(19) United States
(12) Patent Application Publication
(10) Pub. No.: US 2013/0004718 A1
(43) Pub. Date: Jan. 3, 2013

(54) ACTIVE ENERGY RAY CURABLE RESIN COMPOSITION AND ARTICLE HAVING FINE CONCAVE-CONVEX STRUCTURE ON SURFACE

(76) Inventors: Tsuyoshi Takihara, Otake-shi (JP); Katsuhiro Kojima, Otake-shi (JP); Masayuki Uchida, Otake-shi (JP)

(21) Appl. No.: 13/634,290

(22) PCT Filed: Mar. 16, 2011
(86) PCT No.: PCT/JP2011/056187

§ 371 Date: Sep. 12, 2012

(30) Foreign Application Priority Data
Mar. 17, 2010 (JP) 2010-060906

(51) Int. Cl. C08F 22/14; B32B 3/10; C08F 22/20; C08F 2/46; C08F 26/06; C08F 22/22

(52) U.S. Cl. 428/156; 522/167; 522/96; 522/181; 522/183; 522/40; 522/64

(57) ABSTRACT

The present invention relates to an active energy ray-curable resin composition including: a polymerizable component in which the polymerizable component includes 50 to 80% by mass of a monomer having 3 or more radical-polymerizable functional groups, and a molecular weight per functional group is 110 to 200, 10 to 50% by mass of a monomer having 2 radical-polymerizable functional groups, and at least 11 oxyalkylene groups, and 0 to 20% by mass of a monomer having one radical-polymerizable functional group; and a photopolymerization initiator. The present invention can provide an active energy ray-curable resin composition which can have comparatively low viscosity and can form a cured product with an excellent stamper mold releasing property, high abrasion resistance and an excellent fingerprint-wiping property, and an article having a fine concave-convex structure on the surface having high abrasion resistance and an excellent fingerprint-wiping property.

### TECHNICAL FIELD

The present invention relates to an active energy ray-curable resin composition and an article having a fine concave-convex structure formed using the composition on a surface (an anti-reflective product and the like).

Priority is claimed on Japanese Patent Application No. 2010-060906, filed Mar. 17, 2010, the content of which is incorporated herein by reference.

### BACKGROUND ART

Articles having a fine concave-convex structure with a cycle having a wavelength of visible rays or less are known to have an anti-reflective performance due to a continuous change of the refractive index in the fine concave-convex structure. In addition, a fine concave-convex structure is known to show very high water repellence as measured by the Lotus Effect.

As methods of producing articles having a fine concave-convex structure, the following methods have been proposed.

(i) A method in which a stamper mold having a reversed structure of a fine concave-convex structure on a surface is used and the fine concave-convex structure is transferred to a thermoplastic resin when the thermoplastic resin is injection-molded or press-molded.

(ii) A method in which an active energy ray-curable resin composition is filled between a stamper mold having a reversed structure of a fine concave-convex structure on a surface and a transparent substrate, the composition is cured by irradiation of an active energy ray, and then, the fine concave-convex structure is transferred to the cured product by releasing the stamper mold, or a method in which an active energy ray-curable resin composition is filled between the stamper mold and a transparent substrate, the fine concave-convex structure is transferred to the active energy ray-curable resin composition by releasing the stamper mold, and then, the active energy ray-curable resin composition is cured by irradiation of an active energy ray.

Among these, a method (ii) has been receiving attention in terms of its satisfactory transferability of a fine concave-convex structure, high degree of freedom of a surface composition of articles, continuous production capabilities when a stamper mold is either a belt or a roll, and excellent productivity.

As an active energy ray-curable resin composition used in the method (ii), for example, the following compositions have been proposed.

(1) A photo-curable resin composition including an acrylate oligomer such as urethane acrylate, an acryl-based resin having a radical-polymerizable functional group, a releasing agent, and a photopolymerization initiator (PTL 1).

(2) A photo-curable resin composition including (meth)acrylate such as ethoxylated bisphenol A di(meth)acrylate, a reactive diluent such as N-vinylpyridone, a photopolymerization initiator, and a fluorine-based surfactant (PTL 2).

(3) An ultraviolet-curable resin composition including polyfunctional (meth)acrylate such as trimethylolpropane tri(meth)acrylate, a photopolymerization initiator, and a leveling agent such as polyether-modified silicone oil (PTL 3).

However, the photo-curable resin composition of (1) has the following problems.
Viscosity is high since it is mainly composed of oligomers and resins, the photo-curable resin composition may not sufficiently flow into a fine concave-convex structure of a stamper mold, and transferability of a fine concave-convex structure is poor.
The cured product is prone to abrasions by friction since modulus of elasticity is low.
Hydrophilicity of the cured product is insufficient; therefore, it is difficult to wipe off fingerprints and the like even when trying to wipe off dirt such as fingerprints adhered to the cured product (fine concave-convex structure) with a damp cloth since water does not detach the dirt.

The photo-curable resin composition of (2) also has the following problem.
Hydrophilicity of the cured product is insufficient; therefore, it is difficult to wipe off fingerprints and the like even when trying to wipe off dirt such as fingerprints adhered to the cured product (fine concave-convex structure) with a damp cloth since water does not detach the dirt.

The photo-curable resin composition of (3) has a sufficiently high hydrophobicity in the cured product; therefore, it is difficult for dirt such as fingerprints to adhere thereto, however, the photo-curable resin composition of (3) has the following problems.
Viscosity is low since it is mainly composed of polymerizable components having relatively low molecular weights, however, it is difficult to demold a stamper mold since the polymerizable components have low molecular weights, and the cured product is hard and breaks easily.
The cured product is prone to abrasions by friction since the cured product is hard and breaks easily.

Resin compositions disclosed in PTLs 1 to 3 do not sufficiently satisfy abrasion resistance, antifouling property, and productivity. A resin composition to solve these problems is disclosed in PTL 4. A resin composition disclosed in PTL 4 is capable of wiping fingerprint-adhered dirt while maintaining abrasion resistance, however, higher abrasion resistance has been required.

However, a paragraph [0039] of PTL 4 describes that a tetrafunctional or higher polyfunctional (meth)acrylate “becomes poor in appearance due to small cracks on a resin surface if containing more than 50 parts by mass”. In addition, in PTL 5, a polyfunctional monomer having 10 acryloyl groups in one molecule is exemplified, however, the amount used in the examples is a maximum of 47.5 parts by mass.

It has been suggested that abrasion resistance is improved as well by increasing hardness of resin, however, the resin becomes broken at the same time; therefore, abrasion resistance is rather decreased if the hardness is increased too much.

### CITATION LIST

### Patent Literature

[PTL 1] Japanese Patent No. 4156415
[PTL 2] Japanese Laid-Open Patent Application No. 2007-84625
[PTL 3] Japanese Laid-Open Patent Application No. 2000-71290
[PTL 4] International Publication No. WO 2008/096872 pamphlet
[PTL 5] International Publication No. WO 2007/040159 pamphlet

### DISCLOSURE OF INVENTION

### Problems to be Solved by the Invention

The present invention provides an active energy ray-curable resin composition which can have comparatively low viscosity, which has an excellent releasing property from a stamper mold, has high abrasion resistance, and has an excellent fingerprint-wiping property; and an article having a fine concave-convex structure on a surface which has high abrasion resistance and an excellent fingerprint-wiping property.

### Means for Solving the Problem

An active energy ray-curable resin composition of the present invention includes the following polymerizable component (X) and a photopolymerization initiator (D).

### (Polymerizable Component (X))

A polymerizable component (X) includes 50 to 80% by mass of a monomer (A) having 3 or more radical-polymerizable functional groups within a molecule and a molecular weight per functional group is 110 to 200, 10 to 50% by mass of a monomer (B) having 2 radical-polymerizable functional groups within a molecule and at least 11 oxyalkylene groups within a molecule, and 0 to 20% by mass of a monomer (C) having one radical-polymerizable functional group within a molecule.

An article having a fine concave-convex structure on a surface of the present invention is an article having a fine concave-convex structure on a surface, and the fine concave-convex structure is formed by contacting the active energy ray-curable resin composition of the present invention with a stamper mold having a reversed structure of the fine concave-convex structure on the surface and curing the active energy ray-curable resin composition.

The article having the fine concave-convex structure on the surface of the present invention is preferably an anti-reflective product.

In other words, the present invention relates to the aspects described below.

(1) An active energy ray-curable resin composition including a following polymerizable component (X) and a photopolymerization initiator (D):

(Polymerizable Component (X))

wherein the polymerizable component (X) includes 50 to 80% by mass of a monomer (A) having 3 radical or more polymerizable functional groups within a molecule and a molecular weight per functional group is 110 to 200, 10 to 50% by mass of a monomer (B) having 2 radical-polymerizable functional groups within a molecule, and 11 or more oxyalkylene groups within a molecule, and 0 to 20% by mass of a monomer (C) having one radical-polymerizable functional group within a molecule.

(2) The active energy ray-curable resin composition according to (1), wherein the monomer (A) has 3 to 15 radical-polymerizable functional groups within the molecule.

(3) The active energy ray-curable resin composition according to (1) or (2), wherein the monomer (A) is a monomer having a structure derived from at least one compound selected from the group consisting of trimethylolpropane, trimethylolethane, pentaerythritol, glycerol, hexamethylene diisocyanate and isophorone diisocyanate.

(4) The active energy ray-curable resin composition according to any one of (1) to (3), wherein the monomer (A) is at least one monomer selected from the group consisting of trimethylolpropane triacrylate, ethoxylated trimethylolpropane triacrylate, ethoxylated pentaerythritol tetraacrylate, tetrafunctional urethane-based hard acrylate, hexafunctional urethane-based hard acrylate, a mixed reactant of trimethylolethane/acrylic acid/succinic acid=2/4/1, di- to nonafunctional urethane acrylate and ethoxylated dipentaerythritol hexaacrylate.

(5) The active energy ray-curable resin composition according to any one of (1) to (4), wherein the monomer (B) is a monomer having 11 to 30 oxyalkylene groups within a molecule.

(6) The active energy ray-curable resin composition according to any one of (1) to (5), wherein the monomer (B) is at least one monomer selected from the group consisting of polyethylene glycol diacrylate and ethoxylated bisphenol A diacrylate.

(7) The active energy ray-curable resin composition according to any one of (1) to (6), wherein the monomer (C) is at least one monomer selected from the group consisting of acryloyl morpholine, hydroxyethyl acrylate, N,N-dimethyl acrylamide, N-vinyl pyrrolidone, N-vinyl formamide, methyl acrylate and ethyl acrylate.

(8) The active energy ray-curable resin composition according to any one of (1) to (7), wherein the monomer (C) is at least one monomer selected from the group consisting of 2-hydroxyethyl acrylate, acryloyl morpholine, and methyl acrylate.

(9) The active energy ray-curable resin composition according to any one of (1) to (8), wherein the ratio of the photopolymerization initiator (D) is 0.01 to 10 parts by mass with regard to 100 parts by mass of the polymerizable component (X).

(10) The active energy ray-curable resin composition according to any one of (1) to (9), wherein the photopolymerization initiator (D) is 2-hydroxy-2-methyl-1-phenylpropan-1-one or 2,4,6-trimethyl benzoyl diphenylphosphine oxide.

An article having a fine concave-convex structure on a surface,

(11) wherein the fine concave-convex structure is formed by contacting the active energy ray-curable resin composition according to any one of (1) to (10) with a stamper mold having a reversed structure of the fine concave-convex structure on the surface and curing the active energy ray-curable resin composition.

(12) The article having the fine concave-convex structure on the surface according to (11), which is an anti-reflective product.

### EFFECTS OF THE INVENTION

According to the active energy ray-curable resin composition of the present invention, a cured product which can have comparatively low viscosity, has an excellent releasing property from a stamper mold, has high abrasion resistance and has an excellent fingerprint-wiping property may be formed.

The article having a fine concave-convex structure on a surface has high abrasion resistance and an excellent fingerprint-wiping property.

### BRIEF DESCRIPTION OF DRAWINGS

FIG. 1 is a cross-sectional view which shows one example of an article having a fine concave-convex structure on a surface of the present invention.

FIG. 2 is a cross-sectional view which shows a manufacturing process of a stamper mold having anodized alumina on a surface.

FIG. 3 is a configuration diagram which shows one example of manufacturing device of an article having a fine concave-convex structure on a surface of the present invention.

### DESCRIPTION OF EMBODIMENTS

In the present specification, a radical-polymerizable functional group refers to a (meth)acryloyl group, a vinyl group, or the like. The (meth)acryloyl group refers to an acryloyl group and/or a methacryloyl group. In addition, (meth)acrylate refers to acrylate and/or methacrylate. Active energy ray refers to visible rays, ultraviolet rays, an electron beam, plasma, and heat rays (infrared rays).

<Active Energy Ray-Curable Resin Composition>

An active energy ray-curable resin composition is a resin composition which undergoes a polymerization reaction and is cured by being irradiated by active energy ray.

The active energy ray-curable resin composition of the present invention includes a polymerizable component (X) and a photopolymerization initiator (D) as essential components and includes other components such as an ultraviolet ray absorbent and/or an antioxidant (E) as necessary.

Viscosity of the active energy ray-curable resin composition is preferably not too high from the viewpoint of easy inflow into a fine concave-convex structure of a stamper mold surface. Therefore, viscosity of the active energy ray-curable resin composition measured by a rotary B type viscometer at 25° C. is preferably 10,000 mPa·s or less, more preferably 5,000 mPa·s or less, and even more preferably 2,000 mPa·s or less.

However, even when viscosity of the active energy ray-curable resin composition is greater than 10,000 mPa·s, there is no particular problem if viscosity can be lowered by heating in advance during contact with the stamper mold. In this case, viscosity of the active energy ray-curable resin composition measured by a rotary B type viscometer at 70° C. is preferably 5,000 mPa·s or less and more preferably 2,000 mPa·s or less.

If viscosity is too low, moisture spreads and sometimes causes trouble in production. Viscosity of 10 mPa·s or more is preferable.

The range of viscosity measured by a rotary 13 type viscometer at 25° C. is preferably 10 to 10,000 mPa·s, more preferably 10 to 5,000 mPa·s, and even more preferably 10 to 2,000 mPa·s.

The range of viscosity measured by a rotary B type viscometer at 70° C. is preferably 10 to 5,000 mPa·s, and more preferably 10 to 2,000 mPa·s.

(Polymerizable Component (X))

The polymerizable component (X) includes a specific monomer (A) and a specific monomer (B) as essential components and includes as necessary a monomer (C) and other polymerizable components (excluding the monomer (A), the monomer (B), and the monomer (C)).

(Monomer (A))

The monomer (A) is a compound which has 3 or more radical-polymerizable functional groups within a molecule, and in which a molecular weight per functional group is 110 to 200.

The molecular weight per functional group is a value of the molecular weight of the monomer (A) divided by the number of the radical-polymerizable functional groups within the molecule.

The monomer (A) has preferably 3 to 15 radical-polymerizable functional groups within the molecule and more preferably 3 to 10.

For example, in case of trimethylolpropane triacrylate, which is a typical trifunctional monomer, a molecular weight thereof is 296 and the number of the radical-polymerizable functional groups is 3; therefore, a molecular weight per functional group is 98.67. Therefore, the monomer (A) does not include trimethylolpropane triacrylate. Equally, the monomer (A) does not include a tetrafunctional monomer of which a molecular weight is greater than 800 or a hexafunctional monomer of which a molecular weight is greater than 1200, since a molecular weight per functional group is greater than 200.

If a molecular weight per functional group is less than 110, the molecular weight between crosslinking points of the cured product is too small, and therefore, the cured product is hard and breaks easily in some cases. If the molecular weight per functional group is greater than 200, a modulus of elasticity and hardness of the cured product become lower and abrasion resistance is sometimes compromised.

The molecular weight per functional group of the monomer (A) is preferably 120 to 180 and more preferably 130 to 150.

As the monomer (A), urethane (meth)acrylate, epoxy (meth)acrylate, polyester

(meth)acrylate, polyether (meth)acrylate and the like of which a molecular weight per one functional group is 110 to 200 may be included.

Examples of trifunctional polyether (meth)acrylates may include alkoxylated trimethylolpropane tri(meth)acrylate, alkoxylated pentaerythritol tri(meth)acrylate, alkoxylated isocyanuric acid tri(meth)acrylate and the like.

Examples of tetrafunctional polyether (meth)acrylates may include alkoxylated pentaerythritol tetra(meth)acrylate, alkoxylated ditrimethylolpropane tri(meth)acrylate and the like.

Examples of pentafunctional or higher polyether (meth)acrylates may include alkoxylated dipentaerythritol hexa(meth)acrylate and the like.

Here, alkoxylated may include ethoxylated, propoxylated, ethoxylated-propoxylated, butoxylated and the like.

As urethane (meth)acrylates, a reaction product of a polyol, an isocyanate compound and (meth)acrylate having a hydroxyl group may be included and as commercially available products, NK Oligo U-4HA and NK Oligo U-6HA (manufactured by Shin-Nakamura Chemical Co., Ltd.,) and the like may be included.

As polyester (meth)acrylates, a reaction product of trimethylolethane, and succinic acid, and (meth)acrylic acid, and the like may be included.

As the monomer A, ethoxylated trimethylolpropane tri(meth)acrylate, ethoxylated pentaerythritol tri(meth)acrylate, ethoxylated ditrimethylolpropane (meth)acrylate, ethoxylated dipentaerythritol hexa(meth)acrylate, commercially available products of urethane (meth)acrylates (NK Oligo U-4HA and NK Oligo U-6HA,) and the like are preferable from the viewpoint of polymerization reactivity.

The monomer (A) preferably has a structure derived from at least one selected from the group consisting of trimethylolpropane, trimethylolethane, pentaerythritol, glycerin, hexamethylene diisocyanate and isophorone diisocyanate.

The monomer (A) is either used alone or as a combination of two or more.

The ratio of the monomer (A) is 50 to 80% by mass in 100% by mass of the polymerizable component (X), preferably 55 to 80% by mass, more preferably 60 to 80% by mass, even more preferably 60 to 75% by mass, and particularly preferably 60 to 70% by mass. If the ratio of the monomer (A) is less than 50% by mass, a modulus of elasticity and hardness of the cured product become lower and abrasion resistance is sometimes compromised. If the ratio of the monomer (A) is greater than 80% by mass, cracks occur in the cured product when the stamper mold is demolded from the cured product since the modulus of elasticity of the cured product becomes higher, and also, abrasion resistance is sometimes compromised since the cured product is hard and breaks easily.

In the prior art, it was not possible to use tetrafunctional or higher monomers in 50 parts by mass or more since resins were easily broken, however, in the present invention, by using compounds with a molecular weight per functional group of 110 to 200, resins are not broken even when tetrafunctional or higher monomers are used in 50 parts by mass or more, and as a result, abrasion resistance can be effectively improved.

(Monomer (B))

The monomer (B) is a compound having two radical-polymerizable functional groups within a molecule and also having 11 or more oxyalkylene groups (an oxyethylene group: —(CH₂CH₂O)— and the like) within a molecule. That is, the monomer (B) is a compound having a polyoxyalkylene structure (a polyoxyethylene structure: —(CH₂CH₂O)ₙ— and the like).

When the monomer (B) is a mixture of two or more compounds in which the numbers of oxyalkylene groups are different, an average value of the numbers of oxyalkylene groups is used.

In order to improve skin irritation of difunctional or higher monomers, methods are well known in which a polyol as raw material is alkoxylated (ethoxylated, propoxylated and the like) by adding an alkylene oxide (ethylene oxide, propylene oxide and the like) and a molecular weight thereof is increased. The longer the chain length of a polyoxyalkylene structure is, the lower the glass transition temperature of the cured product is, along with less skin irritation; therefore, a flexible cured product is obtained. In addition, in a difunctional or higher monomer, it is well known that reactivity of the rest of the radical-polymerizable functional groups is reduced when one radical-polymerizable functional group is reacted, however, polymerization reactivity is also improved by separating radical-polymerizable functional groups in one molecule by the polyoxyalkylene structure.

The structure of polyoxyalkylene may be composed of single oxyalkylene group or composed of two or more oxyalkylene groups. In addition, other groups such as bisphenol A may be interposed in the middle of the polyoxyalkylene structure.

As the polyoxyalkylene structure, a polyoxyethylene structure is preferable from the viewpoint of a fingerprint-wiping property of the cured product.

If the number of oxyalkylene groups in the polyoxyalkylene structure is 11 or more, excellent polymerization reactivity is exhibited. On the other hand, if the number of oxyalkylene groups is too high, crystallization occurs and a handling property sometimes becomes poor. In addition, abrasion resistance is sometimes compromised since crosslinking density in the cured product is reduced.

The number of oxyalkylene groups is preferably is 11 to 30 and more preferably 11 to 25.

As the monomer (B), polyalkylene glycol di(meth)acrylate, alkoxylated bisphenol A di(meth)acrylate, alkoxylated 2-methyl-1,3-propanediol di(meth)acrylate and the like having 11 or more oxyalkylene groups in the molecule may be included.

As the polyalkylene glycol di(meth)acrylate, for example, polyethylene glycol di(meth)acrylate, polypropylene glycol di(meth)acrylate, polytetramethylene glycol di(meth)acrylate, poly(ethylene glycol-tetramethylene glycol) di(meth)acrylate, poly(propylene glycol-tetramethylene glycol) di(meth)acrylate, poly(ethylene glycol-propylene glycol-ethylene glycol) di(meth)acrylate, and the like, may be included.

As the alkoxylated bisphenol A di(meth)acrylate, ethoxylated bisphenol A di(meth)acrylate, propoxylated bisphenol A di(meth)acrylate, propoxylated ethoxylated bisphenol A di(meth)acrylate, and the like, may be included.

As alkoxylated 2-methyl-1,3-propanediol di(meth)acrylate, ethoxylated 2-methyl-1,3-propanediol di(meth)acrylate and the like may be used.

The monomer (B) may be used either alone or as a combination of two or more.

The ratio of the monomer (B) is 10 to 50% by mass, preferably 15 to 45% by mass, more preferably 15 to 40% by mass, and even more preferably 20 to 40% by mass in 100% by mass of the polymerizable component (X). If the ratio of the monomer (B) is less than 10% by mass, cracks occur in the cured product when the stamper mold is demolded from the cured product since the modulus of elasticity of the cured product becomes higher, and also, abrasion resistance is sometimes compromised since the cured product is hard and breaks easily. If the ratio of the monomer (B) is greater than 50% by mass, the modulus of elasticity and hardness of the cured product become lower and abrasion resistance is sometimes compromised. In addition viscosity of the active energy ray-curable resin composition tends to easily be high.

(Monomer (C))

The monomer (C) is a compound having one radical-polymerizable functional group within the molecule, is capable of being copolymerized with the monomer (A) or the monomer (B), and is added when necessary.

As the monomer (C), a hydrophilic monomer is preferable from the viewpoint of a fingerprint-wiping property of the cured product. The hydrophilic monomer is a monomer of which 1 g or more can be dissolved in 100 g of water at 25° C.

In the active energy ray-curable resin composition, it is a polyfunctional monomer which is made to a main skeleton that greatly influences the properties of the composition. However, many polyfunctional monomers have high viscosity in general, and therefore, are diluted using the monomer (C) of low viscosity in order to improve handling properties. In addition, in a difunctional or higher monomer, the monomer (C) is added in order to improve polymerization reactivity of the entire active energy ray-curable resin composition since reactivity of the rest of the radical-polymerizable functional groups is reduced when one radical-polymerizable functional group is reacted.

In addition, the active energy ray-curable resin composition is rarely cured alone and normally, the active energy ray-curable resin composition is cured on a substrate described later and is used with the substrate as one entity. The monomer (C) of low molecular weight is added in order to satisfactorily adhere the substrate with the cured product. An optimal monomer is selected for adhesion depending on materials of the substrate.

As the monomer (C), for example, an alkyl (meth)acrylate (methyl (meth)acrylate, ethyl (meth)acrylate, n-butyl (meth)acrylate, i-butyl (meth)acrylate, t-butyl (meth)acrylate, 2-ethylhexyl (meth)acrylate, lauryl (meth)acrylate, and the like), benzyl (meth)acrylate, a (meth)acrylate having an alicyclic structure (isobornyl (meth)acrylate, tetrahydrofurfuryl (meth)acrylate, adamantyl (meth)acrylate, dicyclopentanyl (meth)acrylate, dicyclopentenyl (meth)acrylate, and the like), a (meth)acrylate having an amino group (dimethylaminoethyl (meth)acrylate, dimethylaminopropyl (meth)acrylate, and the like), a (meth)acrylate having a hydroxyl group (hydroxyethyl (meth)acrylate, hydroxypropyl (meth)acrylate, and the like), a (meth)acrylamide derivative ((meth)acryloyl morpholine, N,N-dimethyl (meth)acrylamide, and the like), 2-vinyl pyridine, 4-vinyl pyridine, N-vinyl pyrrolidone, N-vinyl formamide, vinyl acetate, and the like may be included.

As the monomer (C), a monomer which is not too bulky is preferable from the viewpoint of polymerization reactivity, and a monomer of which hydrophobicity is not high is preferable from the viewpoint of an antifouling property.

As a measure for bulkiness of the monomer, a molecular weight of 150 or less is preferable. The molecular weight of the monomer (C) is preferably 70 to 150 and more preferably 70 to 115.

Specifically, acryloyl morpholine, hydroxyethyl acrylate, N,N-dimethyl acrylamide, N-vinyl pyrrolidone, N-vinyl formamide, methyl acrylate, ethyl acrylate, and the like, are preferable. If the material of the substrate is acrylic-based resin, methyl acrylate and ethyl acrylate are particularly preferable.

The monomer (C) may be used either alone or as a combination of two or more.

The ratio of the monomer (C) is 0 to 20% by mass, preferably 0 to 15% by mass, more preferably 0 to 10% by mass, even more preferably 1 to 10% by mass, and particularly preferably 3 to 10% by mass in 100% by mass of the polymerizable component (X). If the ratio of the monomer (C) is greater than 20% by mass, curing of the active energy ray-curable resin composition is not completed and an article having a fine concave-convex structure on a surface becomes incomplete sometimes. In addition, unreacted monomer (C) remains in the cured product, acts as a plasticizer and lowers the modulus of elasticity of the cured product, and therefore sometimes impairs abrasion resistance.

(Other Polymerizable Components)

Polymerizable component (X) may include other polymerizable components besides the monomer (A), the monomer (B), and the monomer (C) as long as the effects of the present invention are not impaired. As the other polymerizable components, a difunctional or higher monomer besides the monomer (A) and the monomer (B), an oligomer having a radical-polymerizable functional group, a polymer, or the like, may be included.

The ratio of the other polymerizable components is preferably 30% by mass or less, more preferably 20% by mass or less, and particularly preferably 10% by mass or less in 100% by mass of the polymerizable component (X). That is, total content of the monomer (A), the monomer (B), and the monomer (C) is preferably 70% by mass or more in 100% by mass of the polymerizable component (X).

(Photopolymerization Initiator (D))

The photopolymerization initiator (D) is a compound which is cleaved by irradiation of active energy ray and generates radicals initiating a polymerization reaction. As the active energy ray, ultraviolet rays are preferable from the viewpoint of device costs and productivity.

As the photopolymerization initiator (D) generating radicals by ultraviolet rays, that is, the photopolymerization initiator, for example, benzophenone, 4,4-bis(diethylamino) benzophenone, 2,4,6-trimethyl benzophenone, methyl orthobenzoyl benzoate, 4-phenyl benzophenone, t-butyl anthraquinone, 2-ethyl anthraquinone, thioxanthones (2,4-diethyl thioxanthone, isopropyl thioxanthone, 2,4-dichloro thioxanthone, and the like), acetophenones (diethoxy acetophenone, 2-hydroxy-2-methyl-1-phenylpropan-1-one, benzyl dimethyl ketal, 1-hydroxycyclohexyl-phenyl ketone, 2-methyl-2-morpholino(4-thiomethylphenyl)propan-1-one, 2-benzyl-2-dimethylamino-1-(4-morpholino phenyl)-butanone, and the like), benzoin ethers (benzoin methyl ether, benzoin ethyl ether, benzoin isopropyl ether, benzoin isobutyl ether, and the like), acyl phosphine oxides (2,4,6-trimethylbenzoyl diphenylphosphine oxide, bis(2,6-dimethoxybenzoyl)-2,4,4-trimethylpentylphosphine oxide, bis(2,4,6-trimethylbenzoyl)-phenylphosphine oxide, and the like), methylbenzoyl formate, 1,7-bisacridinyl heptane, 9-phenyl acridine, and the like, may be included.

The photopolymerization initiator may be used either alone or as a combination of two or more. When used as a combination, a combination of two or more having different absorption wavelengths is preferable.

In addition, a thermal polymerization initiator such as a persulfate (potassium persulfate, ammonium persulfate, and the like), a peroxide (benzoyl peroxide and the like), an azo initiator, and the like, may be used as a combination when necessary.

The ratio of the monomer (D) is preferably 0.01 to 10 parts by mass, more preferably 0.1 to 5 parts by mass and even more preferably 0.2 to 3 parts by mass with regard to 100 parts by mass of the polymerizable component (X). If the ratio of the monomer (D) is less than 0.01 parts by mass, curing of the active energy ray-curable resin composition is not completed and mechanical properties of an article having a fine concave-convex structure on a surface is sometimes impaired. If the ratio of the monomer (D) is greater than 10 parts by mass, unreacted photopolymerization initiator (D) remains in the cured product, acts as a plasticizer and lowers the modulus of elasticity, and therefore sometimes impairs abrasion resistance. In addition, discoloration sometimes occurs.

(Ultraviolet Absorbent and/or Antioxidant (E))

The active energy ray-curable resin composition of the present invention may further include an ultraviolet absorbent or an antioxidant (E).

As the ultraviolet absorbent, for example, a benzophenone-based compound, a benzotriazole-based compound, a hindered amine-based compound, a benzoate-based compound, a triazine-based compound, and the like, may be included. As commercially available products, ultraviolet absorbents such as, “TINUVIN 400” or “TINUVIN 479” manufactured by Chiba Specialty Chemical Corporation and “Viosorb110” manufactured by Kyodo Chemical Company Limited may be included.

As the antioxidant, for example, a hindered phenol-based, a benzimidazole-based, a phosphorus-based, a sulfur-based, and a hindered amine-based antioxidant and the like may be used. As commercially available products, “IRGANOX” series manufactured by Chiba Specialty Chemical Corporation and the like may be included.

These ultraviolet absorbents and antioxidants may be used either alone or as a combination of two or more.

The ratio of the ultraviolet absorbent and/or the antioxidant (E) is preferably 0.01 to 5 parts by mass in total with regard to 100 parts by mass of the polymerizable component (X).

(Other Components)

The active energy ray-curable resin composition of the present invention may contain well known additives such as a surfactant, a releasing agent, a lubricant, a plasticizer, an antistatic agent, a light stabilizer, a flame retardant, a flame retardant assistant, a polymerization inhibitor, a filler, a silane coupling agent, a coloring agent, a reinforcing agent, an inorganic filler, an impact resistance reforming agent and the like.

The active energy ray-curable resin composition of the present invention may contain an oligomer not having a radical-polymerizable functional group, or a polymer, and a small amount of organic solvent, and the like.

In the active energy ray-curable resin composition of the present invention described above, a cured product having appropriate hardness is formed in spite of relatively low viscosity since specific monomer (A) and specific monomer (B) are included at specific ratios. As a result, a cured product with an excellent releasing property from the stamper mold may be formed and abrasion resistance is high. A cured product with an excellent fingerprint-wiping property may also be formed since specific monomer (B) is included at a specific ratio.

<Article Having Fine Concave-Convex Structure on Surface>

The article having a fine concave-convex structure on the surface of the present invention is an article having a fine concave-convex structure on the surface formed by contacting the active energy ray-curable resin composition with a stamper mold having a reversed structure of the fine concave-convex structure on the surface and curing the active energy ray-curable resin composition.

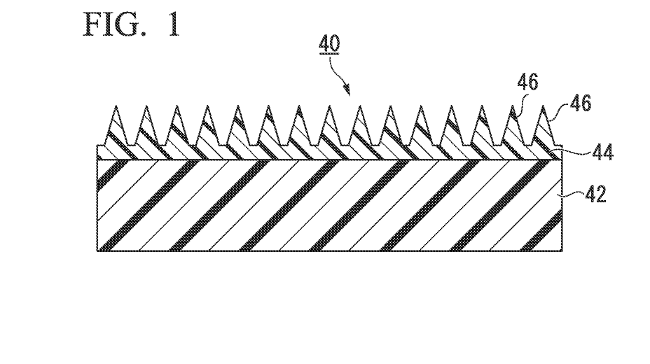

FIG. 1 is a cross-sectional view which shows one example of an article having a fine concave-convex structure on a surface of the present invention. The article 40 has a substrate 42 and a cured resin layer 44 formed on the surface of the substrate 42.

As the substrate 42, a stamper molded body which transmits light is preferable. Materials of the substrate may include, for example, an acrylic-based resin (polymethyl methacrylate and the like), polycarbonate, a styrene (co)polymer, a methyl methacrylate-styrene copolymer, cellulose diacetate, cellulose triacetate, cellulose acetate butyrate, polyester (polyethylene terephthalate and the like), polyamide, polyimide, polyether sulfone, polysulfone, polyolefin (polyethylene, polypropylene, and the like), polymethylpentene, polyvinyl chloride, polyvinyl acetal, polyether ketone, polyurethane, glass, and the like.

The substrate 42 may be an injection molded body, an extrusion molded body, or a cast molded body. The substrate 42 may have a sheet shape or a film shape.

A surface of the substrate 42 may be coated, corona treated or the like in order to improve adhesion, an antistatic property, abrasion resistance, weather resistance, and the like.

The cured resin layer 44 is a film composed of the active energy ray-curable resin composition of the present invention and has a fine concave-convex structure on the surface.

The fine concave-convex structure on the surface of the article 40, when a stamper mold of anodized alumina described later is used, is formed by transferring the fine concave-convex structure on the surface of the anodized alumina, and has two or more protrusion units 46 composed of the cured product of the active energy ray-curable resin composition.

As the fine concave-convex structure, a so-called moth-eye structure in which two or more protuberances (protrusion units) in an approximate cone shape, a pyramid shape or the like, are lined up is preferable. The moth-eye structure, in which a space between the protuberances is the wavelength of visible rays or less, is known to be refers to of effective anti-reflection by the refractive index continuously increasing from the refractive index of air to the refractive index of the material.

An average space between the protrusion units is preferably less than or equal to the wavelength of visible rays, that is 400 nm or less. If the average space is greater than 400 nm, uses for optical applications such as anti-reflective products are not suitable since scattering of visible rays occurs. When the protrusion unit is formed using a stamper mold of anodized alumina described later, an average space between the protrusion units is, from being approximately 100 nm, more preferably 200 nm or less and particularly preferably 150 nm or less.

An average space between the protrusion units is preferably 20 nm or more from the viewpoint of the easy formation of the protrusion unit.

The range of average space between the protrusion units is preferably 20 to 400 nm, more preferably 20 to 200 nm, and even more preferably 20 to 150 nm.

The average space between the protrusion units is determined by measuring the space between the protrusion units adjacent to each other at 50 points using electron microscopy (a distance from the center of a protrusion unit to the center of an adjacent protrusion unit), and by averaging these values.

The height of the protrusion unit is preferably 80 to 500 nm, more preferably 120 to 400 nm, and particularly preferably 150 to 300 nm if the average space is 100 nm. If the height of the protrusion unit is 80 nm or more, reflectivity becomes sufficiently low and the wavelength dependence of reflectivity is small. If the height of the protrusion unit is 500 nm or less, abrasion resistance of the protrusion unit is satisfactory.

The height of the protrusion unit is a value measuring the distance between the very top of the protrusion unit and the very bottom of a recess unit present between the protrusion units when viewed at a magnification of 30,000 times by electron microscopy.

An aspect ratio of the protrusion unit (height of the protrusion unit/average space between the protrusion units) is preferably 0.8 to 5, more preferably 1.2 to 4, and particularly preferably 1.5 to 3. If the aspect ratio of the protrusion unit is 1.0 or more, reflectivity becomes sufficiently low. If the aspect ratio of the protrusion unit is 5 or less, abrasion resistance of the protrusion unit is satisfactory.

As the shape of the protrusion unit, a shape in which a cross-sectional area of the protrusion unit of the direction perpendicular to a height direction continuously increases from the outermost surface to a depth direction, that is, a shape in which a cross-sectional shape of the height direction of the protrusion unit is a triangle shape, a trapezoid shape, a bell shape and the like, is preferable.

A difference between refractive index of the cured resin layer 44 and refractive index of the substrate 42 is preferably 0.2 or less, more preferably 0.1 or less, and particularly preferably 0.05 or less. If the refractive index difference is 0.2 or less, reflection at the interface between the cured resin layer 44 and the substrate 42 may be suppressed.

(Stamper Mold)

A stamper mold is that which has a reversed structure of the fine concave-convex structure.

As a material of the stamper mold, metal (including those in which an oxide film is formed on the surface), quartz, glass, resin, ceramics, and the like may be included.

As a shape of the stamper mold, a roll shape, a tube shape, a flat plate shape, a sheet shape, and the like may be included.

As a method of producing the stamper mold, for example, the following method (I-1) and the method (I-2) may be included, and the method (I-1) is particularly preferable in terms that making a stamper mold with large area is possible and preparation is simple.

(I-1) A method in which an anodized alumina having two or more pores (the recess unit) is formed on a surface of the aluminum substrate.

(I-2) A method in which a reversed structure of the fine concave-convex structure is formed on a surface of the substrate of the stamper mold by an electron beam lithography method or a laser light interference method.

As the method (I-1), a method having the following steps (a) to (f) is preferable.

(a) A step in which an oxide film is formed on the surface of the aluminum substrate by anodizing the aluminum substrate in an electrolyte solution and under constant voltage.

(b) A step in which the oxide film is removed and pore generation points of anodization are formed on the surface of the aluminum substrate.

(c) A step after (b), in which the aluminum substrate is anodized again in an electrolyte solution and an oxide film which has pores in the pore generation points is formed.

(d) A step after (c), in which diameters of the pores are expanded.

(e) A step after (d), in which the aluminum substrate is anodized again in an electrolyte solution.

(f) A step in which the step (d) and the step (e) are repeated and a stamper mold in which the anodized alumina having two or more pores is formed on the surface of the aluminum substrate is obtained.

Step (a):

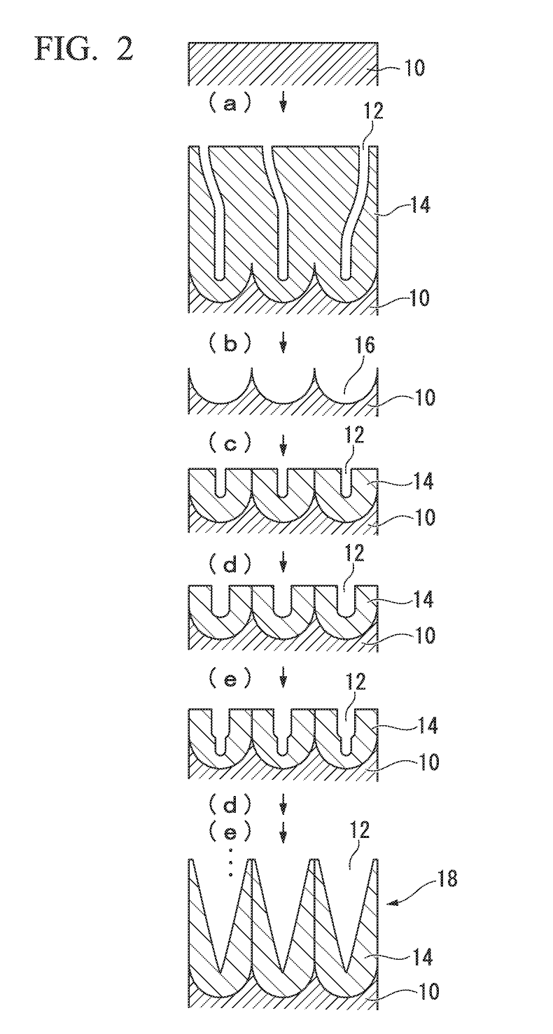

As shown in FIG. 2, the oxide film 14 having pores 12 is formed when the aluminum substrate 10 is anodized.

As the shape of the aluminum substrate, a roll shape, a tube shape, a flat plate shape, a sheet shape, and the like, may be included.

The aluminum substrate is preferably degreased in advance since oil used in processing the substrate into a predetermined shape is sometimes attached thereto. In addition, the aluminum substrate is preferably electrolytically polished (etched) in order to smoothen the surface state.

A purity of the aluminum is preferably 99% or more, more preferably 99.5% or more, and particularly preferably 99.8% or more. If the purity of the aluminum is low, a fine concave-convex structure of a size scattering visible rays by the segregation of impurities is sometimes formed, or regularity of the pore obtained by anodization is sometimes reduced, when anodized.

As the electrolytic solution, sulfuric acid, oxalic acid, phosphoric acid and the like may be included.

When oxalic acid is used as the electrolyte solution:

A concentration of the oxalic acid is preferably 0.7 M or less. If the concentration of the oxalic acid is greater than 0.7 M, a current value becomes too high and the surface of the oxide film sometimes appears grainy.

When a formation voltage is 30 to 60 V, an anodized alumina having pores with high regularity of cycles of 100 nm may be obtained. A formation voltage either higher or lower than this range tends to decrease the regularity.

A temperature of the electrolyte solution is preferably 60° C. or less and more preferably 45° C. or less. If temperature of the electrolyte solution is greater than 60° C., a phenomenon so-called “burning” occurs, and sometimes pores are destroyed or the regularity of the pores breaks due to surface melting.

When sulfuric acid is used as the electrolyte solution:

A concentration of the sulfuric acid is preferably 0.7 M or less. If the concentration of the sulfuric acid is greater than 0.7 M, a current value becomes too high and a constant voltage cannot be maintained sometimes.

When the formation voltage is 25 to 30 V, an anodized alumina having pores with high regularity of cycles of 63 nm may be obtained. A formation voltage either higher or lower than this range tends to decrease the regularity.

A temperature of the electrolyte solution is preferably 30° C. or less and more preferably 20° C. or less. If the temperature of the electrolyte solution is greater than 30° C., a phenomenon so-called “burning” occurs, and sometimes pores are destroyed or the regularity of the pores breaks due to surface melting.

Step (b):

As shown in FIG. 2, regularity of the pores can be improved by removing the oxide film 14 first and then making it be the pore generation point 16 of the anodization.

As the method of removing the oxide film, a method in which the oxide film is removed by being dissolved in a solution which selectively dissolves the oxide film without dissolving the aluminum may be included. The solution such as this includes, for example, a mixture solution of chromic acid/phosphoric acid, and the like.

Step (c):

As shown in FIG. 2, the oxide film 14 having cylindrical pores 12 is formed when the aluminum substrate 10 in which the oxide film is removed is anodized again.

Anodization may be carried out under the same conditions as those of step (a). The longer the anodization time is, the deeper the pores obtained are.

Step (d):

As shown in FIG. 2, a treatment to expand the diameter of the pores 12 (hereinafter referred to as a pore diameter expansion treatment) is performed. The pore diameter expansion treatment is a treatment to expand the diameter of the pores obtained from anodization by immersing in a solution which dissolves the oxide film. The solution such as this includes, for example, an approximately 5% by mass of aqueous solution of phosphoric acid and the like.

The longer the time of the pore diameter expansion treatment is, the larger the diameter of the pores is.

Step (e):

As shown in FIG. 2, the cylindrical pores 12 with small diameters, extended down from the bottom of the cylindrical pore 12, are further formed when anodized again.

Anodization may be carried out under the same conditions as those of step (a). The longer the anodization time is, the deeper the pores obtained are.

Step (1):

As shown in FIG. 2, if the pore diameter expansion treatment of the step (d) and the anodization of the step (e) are repeated, the oxide film 14 having the pores 12 of a shape in which a diameter continuously decreases toward a depth direction from an opening unit is formed, and the stamper mold 18 having anodized alumina (a porous oxide film of aluminum (alumite)) on the surface of the aluminum substrate 10 is obtained. It is preferable that the step be finished with the step (d).

A number of repetitions is preferably three or more in total, and more preferably five or more. If the number of repetitions is two or less, the diameter of the pores non-continuously decreases; therefore, a reflectivity reduction effect of the moth-eye structure formed using an anodized alumina having pores such as this is insufficient.

The shape of the pores 12 may include an approximate cone shape, a pyramid shape, a cylinder shape and the like, and a shape in which a pore cross-sectional area of the direction perpendicular to a depth direction continuously decreases from the outermost surface toward the depth direction such as a cone shape, a pyramid shape and the like, is preferable.

An average space between the pores 12 is preferably less than or equal to the wavelength of visible rays, that is 400 nm or less. An average space between the pores 12 is preferably 20 nm or more.

The average space between the pores 12 is determined by measuring the spaces between the pores 12 adjacent to each other at 50 points using electron microscopy (the distance from the center of a pore 12 to the center of an adjacent pore 12), and by averaging these values.

A depth of the pore 12 is preferably 80 to 500 nm, more preferably is 120 to 400 nm, and particularly preferably 150 to 300 nm, if the average space is 100 nm. The depth of the pore 12 is a value measuring the distance between the very bottom of the pore 12 and the very top of the protrusion unit present between the pores 12 when viewed at a magnification of 30,000 times by electron microscopy.

An aspect ratio of the pore 12 (height of the pore/average space between the pores) is preferably 0.8 to 5.0, more preferably 1.2 to 4.0, and particularly preferably 1.5 to 3.0.

The surface of the side at which the fine concave-convex structure of the stamper mold is formed may be treated with a releasing agent.

As the releasing agent, a silicone resin, a fluorine resin, a fluorine compound, and the like may be included, and a fluorine compound having a hydrolyzable silyl group is particularly preferable. Examples of commercially available products of the fluorine compound having a hydrolyzable silyl group include a fluoroalkylsilane, KBM-7803 (manufactured by Shin-Etsu Chemical Co., Ltd.), MRAF (manufactured by Asahi Glass Co., Ltd.), OPTOOL HD1100 and HD2100 series (manufactured by HARVES Co., Ltd.,), OPTOOL AES4 and AES6 (manufactured by Daikin Industries, Ltd.), and Novec EGC-1720 (manufactured by Sumitomo 3M Limited), FS-2050 series (manufactured by Fluoro Technology Co., Ltd.), and the like.

(Method of Manufacturing Article)

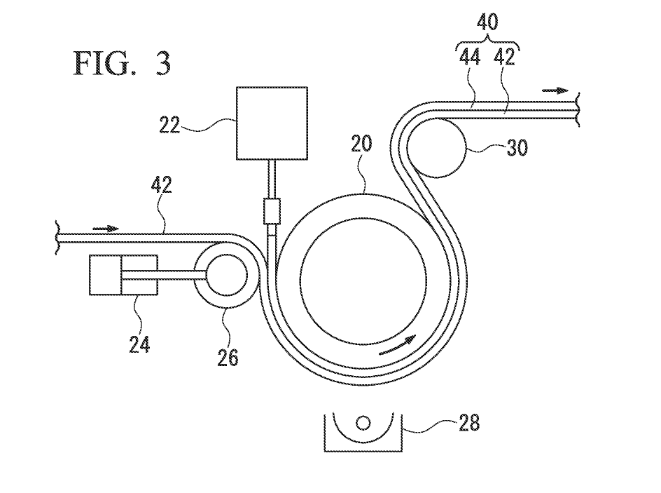

An article having the fine concave-convex structure on a surface is manufactured as follows using, for example, manufacturing devices shown in FIG. 3.

The active energy ray-curable resin composition is supplied from the tank 22 between the roll-shaped stamper mold 20 having a reversed structure (not shown) of the fine concave-convex structure on a surface and the substrate 42 of a strip-shaped film moving along the surface of the roll-shaped stamper mold 20.

The substrate 42 and the active energy ray-curable resin composition is nipped between the roll-shaped stamper mold 20 and a nip roll 26 of which nip pressure is adjusted by a pneumatic cylinder 24, and the active energy ray-curable resin composition is filled within the recess unit of the fine concave-convex structure of the roll-shaped stamper mold 20, and at the same time is made to uniformly reach between the substrate 42 and the roll-shaped stamper mold 20.

Active energy ray irradiates the active energy ray-curable resin composition from the active energy ray irradiation device 28 installed at the bottom of the roll-shaped stamper mold 20 through the substrate 42, cures the active energy ray-curable resin composition, and as a result, the cured resin layer 44 is formed in which the fine concave-convex structure on the surface of the roll-shaped stamper mold 20 is transferred.

The article 40 shown in FIG. 1 is obtained by peeling the substrate 42 in which the cured resin layer 44 is formed on the surface from the roll-shaped stamper mold 20 by a peeling roll 30.

As the active energy ray irradiation device 28, a high-pressure mercury lamp, a metal halide lamp and the like are preferable, and the energy amount of light irradiated in this case is preferably 100 to 10000 mJ/cm².

The substrate 42 is an optically transparent film. As a material of the film, an acrylic-based resin, polycarbonate, a styrene-based resin, polyester, a cellulose-based resin (triacetyl cellulose and the like), polyolefin, alicyclic polyolefin, and the like, may be included.

(Applications)

The article having the fine concave-convex structure of the present invention may be expected to be applied as an anti-reflective product (an anti-reflective film and an anti-reflective membrane), in an optical product such as an optical waveguide, a relief hologram, a lens, and a polarization separating element, and a cell culture sheet, and is particularly suitable for the use in anti-reflective products.

As the anti-reflective products, for example, an anti-reflective membrane, an anti-reflective film, an anti-reflective sheet and the like provided on the surface of an image display device (a liquid crystal display device, a plasma display panel, an electroluminescent display, a cathode ray tube display device, and the like), a lens, a display window, glasses and the like, may be included. When used in an image display device, an anti-reflective film may be directly attached to an image display surface, an anti-reflective membrane may be directly formed on the surface of a member constituting an image display surface, or an anti-reflective membrane may be formed on a front plate.

In the article having the fine concave-convex structure of the present invention described above, abrasion resistance of the fine concave-convex structure is high and a fingerprint-wiping property is excellent since the active energy ray-curable resin composition of the present invention is used.

### EXAMPLES

Hereinafter, the present invention will be described in more detail by examples. In addition, in the following description, “parts” refers to “parts by mass” unless otherwise specified.

(Abrasion resistance)

Appearances of the surface of the sample were visually evaluated by being moved back and forth 5000 times at a round-trip distance of 30 mm and a head speed of 30 mm/sec using an abrasion tester (“HEIDON”, manufactured by Shinto Scientific, Co., Ltd.) with a load of 10 g on a 1 cm square flannel cloth placed on the surface of the sample (the article) of which a back was painted black with lacquer spray. Evaluation was performed by tilting the sample in many directions under a fluorescent lamp (1000 lux) at room temperature of 23° C. and relative humidity of 65%.

B: There was no abrasion.

C: One or two abrasions were identified.

D: 3 or more abrasions were identified.

(Fingerprint-Wiping Property)

Appearances of the surface of the sample were visually evaluated after wiping the surface of the sample on which fingerprints were adhered once by loading 10 g on a 1 cm square using a cleaning cloth (Toreshi, manufactured by Toray Industries Inc.,) wrung to such an extent that water no longer dripped after water was made to be sufficiently soaked by immersing for 3 seconds in a water tank filled with tap water, within 5 minutes after adhering fingerprints of one index finger on the surface of the sample (the article) painted black with lacquer spray on the back. Evaluation was performed by tilting the sample in many directions under a fluorescent lamp (1000 lux) at room temperature of 23° C. and relative humidity of 65%.

B: Dirt was not observed by visual inspection.

C: A few fingerprints were identified by visual inspection.

D: Fingerprints were just spread out and were not wiped off

(Water Resistance)

Appearances of the surface of the sample were visually evaluated by loading the sample (the article) on a black backing sheet, loading 10 g on a 1 cm square using a cleaning cloth (Toreshi (registered trademark), manufactured by Toray Industries Inc.,) wrung to such an extent that water no longer dripped after water was made to be sufficiently soaked by immersing the sample for 3 seconds in a water tank filled with tap water, after wiping the surface of the sample once. Evaluation was performed by tilting the sample in many directions under a fluorescent lamp (1000 lux) at room temperature of 23° C. and relative humidity of 65%.

B: There was no difference between the place wiped and the place not wiped.

C: The place wiped was slightly foggy.

D: The place wiped was obviously cloudy. It was identifiable even when the black backing sheet was removed.

(Releasing Property)

The fine concave-convex structure transferred was observed with a magnification of 10,000 using an electron microscope and it was confirmed whether the tip of the protuberance had no defects and the stamper mold shape was transferred. It was determined to be D if there were defects.

(Adhesion)

A 180-degree peel test was performed at the head speed of 10 mm/sec using a universal tensile testing machine (Tensilon, manufactured by A&D Company, Limited) for the interface between the substrate (film) and the cured resin layer of the laminated body cut into strips of a width of 20 mm. An average value of the stress from the beginning to the end of the peeling was used as adhesion strength.

A: The cured resin layer and the film were sufficiently attached and the film was broken. (Peeling at the interface did not occur.)

B: Adhesion strength was greater than or equal to 0.3 N/mm.

C: Adhesion strength was greater than or equal to 0.1 N/mm and less than 0.3 N/mm.

D: Adhesion strength was less than 0.1 N/mm.

(Manufacturing of Stamper Mold)

An aluminum plate of 99.99% purity was electrolytically polished (volume ratio 1/4) in an aircraft cloth polishing and a mixed solution of perchloric acid/ethanol, and was made to be a surface of a mirror.

Step (a):

The above aluminum plate was anodized in an aqueous solution of 0.3 M oxalic acid for 30 minutes under the conditions of a direct current of 40 V and a temperature of 16° C.

Step (b):

The oxide film was removed by immersing the aluminum plate on which the oxide film was formed in a mixed aqueous solution of 6% by mass of phosphoric acid/1.8% by mass of chromium acid for 6 hours.

Step (c):

The above aluminum plate was anodized in an aqueous solution of 0.3 M oxalic acid for 30 minutes under the conditions of a direct current of 40 V and a temperature of 16° C.

Step (d):

A pore diameter expansion treatment was carried out by immersing the aluminum plate on which the oxide film was formed in 5% by mass of phosphoric acid at 32° C. for 8 minutes.

Step (e):

The above aluminum plate was anodized in an aqueous solution of 0.3 M oxalic acid for 30 seconds under the conditions of a direct current of 40 V and a temperature of 16° C.

Step (f):

The step (d) and the step (e) were repeated four times in total and the step (d) was performed at the end and as a result, a stamper mold in which the anodized alumina having pores in an approximate cone shape with an average space of 100 nm and a height of 180 nm on the surface was obtained.

After washing the stamper mold obtained with deionized water, moisture on the surface was removed by blowing air, the stamper mold was immersed in a solution diluted by a diluent HD-ZV (HAEVES Co., Ltd.) so that the solid content of OPTOOL DSX (manufactured by Daikin Industries, Ltd.) was 0.1% by mass for 10 minutes, was raised from the solution, air dried for 20 hours, and a stamper mold treated with a releasing agent was obtained.

### Polymerization Reactive Monomer Component

### Synthesis Example 1

### Synthesis of Urethane Acrylate Compound (UA1)

117.6 g (0.7 mol) of hexamethylene diisocyanate as an isocyanate compound, 151.2 g (0.3 mol) of hexamethylene diisocyanate trimer of isocyanurate type, 128.7 g (0.99 mol) of 2-hydroxypropyl acrylate as a (meth)acryloyl compound having a hydroxyl group, 693 g (1.54 mol) of pentaerythritol triacrylate, 100 ppm of tin di-n-butyl dilaurate as a catalyst and 0.55 g of hydroquinone monomethyl ether as a polymerization inhibitor were placed in a flask made of glass, and were reacted under the conditions of 70 to 80° C. until the concentration of residual isocyanate became 0.1% or less, and then, a urethane acrylate compound (UA1) was obtained.

(Monomer (A))

Monomers (A) used in the examples were as follows.

TABLE 1

| | | | Molecular Weight/ |
|---|---|---|---|
| | Number of | Molecular | Number of |
| Abbreviation | Functional Groups | Weight | Functional Groups |
| TMPT | 3 | 296 | 97 |
| TMPT-3EO | 3 | 428 | 143 |
| ATM-4E | 4 | 528 | 132 |
| U-4HA | 4 | 568 to 590 | 142 to 148 |
| U-6HA | 6 | 1146 | 191 |
| TAS | 4 | 454 | 113.5 |
| UA1 | 2 to 9 | — | 148 |
| TMPT-9EO | 3 | 692 | 231 |
| DPHA-12EO | 6 | 1110 | 185 |

Abbreviations in the Table are as follows.
TMPT: trimethylolpropane triacrylate (manufactured by Shin-Nakamura Chemical Co., Ltd., A-TMPT),
TMPT-3EO: ethoxylated trimethylolpropane triacrylate (manufactured by Shin-Nakamura Chemical Co., Ltd., A-TMPT-3EO),
ATM-4E: ethoxylated pentaerythritol tetraacrylate (manufactured by Shin-Nakamura Chemical, ATM-4E),
U-4HA: tetrafunctional urethane-based hard acrylate (manufactured by Shin-Nakamura Chemical Co., Ltd., U-4HA),
U-6HA: hexafunctional urethane-based hard acrylate (manufactured by Shin-Nakamura Chemical Co., Ltd., U-6HA),
TAS: reaction mixture in which the ratio of trimethylolethane/acrylic acid/succinic acid is 2/4/1
UA1: difunctional to nonafunctional urethane acrylate
TMPT-9EO: ethoxylated trimethylolpropane triacrylate (manufactured by Shin-Nakamura Chemical Co., Ltd., A-TMPT-9EO),
DPHA-12EO: ethoxylated dipentaerythritol hexaacrylate (manufactured by Nippon Kayaku Co., Ltd., Kayarad DPEA-12).

(Monomer (B))

Monomers (B) used in the examples are as follows.

TABLE 2

| Abbreviation | Number of Oxyalkylene Groups |
|---|---|
| A-200 | 4 |
| A-400 | 9 |
| A-600 | 13 |
| A-1000 | 23 |
| APG-400 | 7 |
| A-BPE-10 | 10 |
| A-BPE-30 | 30 |
| C6DA | 0 |

Abbreviations in the Table are as follows.
A-200: polyethylene glycol diacrylate (manufactured by Shin-Nakamura Chemical Co., Ltd., A-200),
A-400: polyethylene glycol diacrylate (manufactured by Shin-Nakamura Chemical Co., Ltd., A-400),
A-600: polyethylene glycol diacrylate (manufactured by Shin-Nakamura Chemical Co., Ltd., A-600),
A-1000: polyethylene glycol diacrylate (manufactured by Shin-Nakamura Chemical Co., Ltd., A-1000),
APG-400: polypropylene glycol diacrylate (manufactured by Shin-Nakamura Chemical Co., Ltd., APG-400),
A-BPE-10: ethoxylated bisphenol A diacrylate (manufactured by Shin-Nakamura Chemical Co., Ltd., A-BPE-10),
A-BPE-30: ethoxylated bisphenol A diacrylate (manufactured by Shin-Nakamura Chemical Co., Ltd., A-BPE-30),
C6DA: 1,6-hexanediol diacrylate.

(Monomer (C))

Monomers (C) used in the examples are as follows.

HEA: 2-hydroxyethyl acrylate,

ACMO: acryloyl morpholine,

MA: methyl acrylate.

(Photopolymerization Initiator (D))

Photopolymerization initiators (D) used in the examples are as follows.

1173: 2-hydroxy-2-methyl-1-phenylpropan-1-one (manufactured by Nihon Ciba-Geigy K.K., DAROCURE 1173),

TPO: 2,4,6-trimethylbenzoyl diphenylphosphine oxide (manufactured by Nihon Ciba-Geigy K.K. DAROCURE TPO).

### Example 1

60 parts of TMPT-3EO,

40 parts of A-600,

0.5 parts of 1173, and

0.5 parts of TPO

were mixed and the active energy ray-curable resin composition was prepared.

The active energy ray-curable resin composition was added dropwise to the surface of a stamper mold and was coated while being spread on a polyethylene terephthalate film (manufactured by Toyobo Co., Ltd., A-4300) of thickness of 188 μm, and then was cured by ultraviolet radiation with energy of 2000 mJ/cm² from the film side using a high-pressure mercury lamp. An article having a fine concave-convex structure on a surface with an average space of protrusion units of 100 nm and a height of 180 nm was obtained by releasing the stamper mold from the film. The results are shown in Table. 3.

### Examples 2 to 51, Comparative Examples 1 to 18

Articles having a fine concave-convex structure were obtained in the same manner as that of Example 1 except that the compositions of the active energy ray-curable resin composition were changed to compositions shown in Table 3 to Table 9 and Table 12. The results are shown in Table 3 to Table 9 and Table 12.

TABLE 3

| | | Examples | | | | | | | | |
|---|---|---|---|---|---|---|---|---|---|---|
| Composition (Parts) | | 1 | 2 | 3 | 4 | 5 | 6 | 7 | 8 | 9 |
| (A) | TMPT | | | | | | | | | |
| | TMPT-3EO | 60 | 50 | 50 | 55 | 60 | | | | |
| | ATM4E | | | | | | 80 | 70 | 60 | 50 |
| (B) | A-200 | | | | | | | | | |
| | A-400 | | | | | | | | | |
| | A-600 | 40 | 50 | | 35 | 35 | 20 | 30 | 40 | 50 |
| | A-1000 | | | 50 | | | | | | |
| | APG-400 | | | | | | | | | |
| (C) | HEA | | | | 10 | 5 | | | | |
| | MA | | | | | | | | | |
| (D) | 1173 | 0.5 | 0.5 | 0.5 | 0.5 | 0.5 | 0.5 | 0.5 | 0.5 | 0.5 |
| | TPO | 0.5 | 0.5 | 0.5 | 0.5 | 0.5 | 0.5 | 0.5 | 0.5 | 0.5 |

| | | | | | | | | | |
|---|---|---|---|---|---|---|---|---|---|
| Abrasion Resistance | B | B | B | C | B | B | B | B | B |
| Fingerprint-wiping | B | B | B | B | B | C | B | B | B |
| Property | | | | | | | | | |
| Water Resistance | B | C | C | C | B | B | B | C | C |
| Releasing Property | B | B | B | B | B | B | B | B | B |

TABLE 4

| | | Comparative Examples | | | | | | |
|---|---|---|---|---|---|---|---|---|
| Composition (Parts) | | 1 | 2 | 3 | 4 | 5 | 6 | 7 |
| (A) | TMPT | 50 | 60 | 75 | | | | |
| | TMPT-3EO | | | | 60 | 60 | 50 | |
| | ATM4E | | | | | | | 30 |
| (B) | A-200 | | | | 40 | | | |
| | A-400 | | | | | 40 | | |
| | A-600 | 50 | 40 | 25 | | | | 70 |
| | A-1000 | | | | | | | |
| | APG-400 | | | | | | 50 | |
| (C) | HEA | | | | | | | |
| | MA | | | | | | | |
| (D) | 1173 | 0.5 | 0.5 | 0.5 | 0.5 | 0.5 | 0.5 | 0.5 |
| | TPO | 0.5 | 0.5 | 0.5 | 0.5 | 0.5 | 0.5 | 0.5 |

| | | | | | | | |
|---|---|---|---|---|---|---|---|
| Abrasion Resistance | D | D | D | D | D | D | B |
| Fingerprint-wiping | B | B | C | D | C | D | B |
| Property | | | | | | | |
| Water Resistance | C | B | B | B | B | B | D |
| Releasing Property | B | B | B | B | B | B | B |

TABLE 5

| | | Examples | | | | | | | | | |
|---|---|---|---|---|---|---|---|---|---|---|---|
| Composition (Parts) | | 10 | 11 | 12 | 13 | 14 | 15 | 16 | 17 | 18 | 19 |
| (A) | U-4HA | 70 | 60 | 50 | 55 | 55 | 55 | 65 | 60 | 65 | 65 |
| | U-6HA | | | | | | | | | | |
| | TAS | | | | | | | | | | |
| (B) | A-600 | 30 | 40 | 50 | 35 | 35 | 35 | 25 | 20 | 25 | 25 |
| | A-1000 | | | | | | | | | | |
| | A-BPE-10 | | | | | | | | | | |
| | A-BPE-30 | | | | | | | | | | |
| | C6DA | | | | | | | | | | |
| (C) | HEA | | | | 10 | | | 10 | 20 | | 8 |
| | ACMO | | | | | 10 | | | | 10 | |
| | MA | | | | | | 10 | | | | 2 |
| (D) | 1173 | 0.5 | 0.5 | 0.5 | 0.5 | 0.5 | 0.5 | 0.5 | 0.5 | 0.5 | 0.5 |
| | TPO | 0.5 | 0.5 | 0.5 | 0.5 | 0.5 | 0.5 | 0.5 | 0.5 | 0.5 | 0.5 |

| | | | | | | | | | | |
|---|---|---|---|---|---|---|---|---|---|---|
| Abrasion Resistance | B | B | B | C | C | C | B | B | C | B |
| Fingerprint-wiping | C | B | B | B | B | B | B | B | B | C |
| Property | | | | | | | | | | |
| Water Resistance | B | B | C | C | C | C | B | C | C | B |
| Releasing Property | B | B | B | B | B | B | B | B | B | B |

TABLE 6

| | | Examples | | | | | | | | |
|---|---|---|---|---|---|---|---|---|---|---|
| Composition (Parts) | | 20 | 21 | 22 | 23 | 24 | 25 | 26 | 27 | 28 |
| (A) | U-4HA | 65 | 65 | 65 | 60 | 60 | 73 | 60 | 60 | 67 |
| | U-6HA | | | | | | | | | |
| | TAS | | | | | | | | | |
| (B) | A-600 | 25 | 25 | 25 | 30 | 30 | 18 | 37 | 35 | 30 |
| | A-1000 | | | | | | | | | |
| | A-BPE-10 | | | | | | | | | |
| | A-BPE-30 | | | | | | | | | |
| | C6DA | | | | | | | | | |
| (C) | HEA | 7 | 5 | 3 | 7 | 5 | 9 | | | |
| | ACMO | | | | | | | | | |
| | MA | 3 | 5 | 7 | 3 | 5 | | 3 | 5 | 3 |
| (D) | 1173 | 0.5 | 0.5 | 0.5 | 0.5 | 0.5 | 0.5 | 0.5 | 0.5 | 0.5 |
| | TPO | 0.5 | 0.5 | 0.5 | 0.5 | 0.5 | 0.5 | 0.5 | 0.5 | 0.5 |

| | | | | | | | | | |
|---|---|---|---|---|---|---|---|---|---|
| Abrasion Resistance | B | B | B | B | B | B | B | B | B |
| Fingerprint-wiping | B | B | C | B | B | B | B | B | B |
| Property | | | | | | | | | |
| Water Resistance | B | B | B | C | C | B | B | B | B |
| Releasing Property | B | B | B | B | B | B | B | B | B |

TABLE 7

| | | Examples | | | | | | | | |
|---|---|---|---|---|---|---|---|---|---|---|
| Composition (Parts) | | 29 | 30 | 31 | 32 | 33 | 34 | 35 | 36 | 37 |
| (A) | U-4HA | 68 | 63 | 80 | 70 | 60 | 60 | 50 | | |
| | U-6HA | | | | | | | | 80 | 70 |
| | TAS | | | | | | | | | |
| (B) | A-600 | 22 | 27 | | | | | | 20 | 30 |
| | A-1000 | | | 20 | 30 | 40 | | | | |
| | A-BPE-10 | | | | | | | | | |
| | A-BPE-30 | | | | | | 40 | 50 | | |
| | C6DA | | | | | | | | | |
| (C) | HEA | 7 | 7 | | | | | | | |
| | ACMO | | | | | | | | | |
| | MA | 3 | 3 | | | | | | | |
| (D) | 1173 | 0.5 | 0.5 | 0.5 | 0.5 | 0.5 | 0.5 | 0.5 | 0.5 | 0.5 |
| | TPO | 0.5 | 0.5 | 0.5 | 0.5 | 0.5 | 0.5 | 0.5 | 0.5 | 0.5 |

| | | | | | | | | | |
|---|---|---|---|---|---|---|---|---|---|
| Abrasion Resistance | B | B | B | B | B | B | B | B | B |
| Fingerprint-wiping | B | B | C | C | B | C | B | B | B |
| Property | | | | | | | | | |
| Water Resistance | B | B | B | B | B | B | C | B | B |
| Releasing Property | B | B | B | B | B | B | B | B | B |

TABLE 8

| | | Examples | | | | | | | | |
|---|---|---|---|---|---|---|---|---|---|---|
| Composition (Parts) | | 38 | 39 | 40 | 41 | 42 | 43 | 44 | 45 | 46 |
| (A) | U-4HA | | | | | | | | | |
| | U-6HA | 60 | 50 | 67 | 65 | | | | | |
| | TAS | | | | | 70 | 65 | 65 | 72 | 64 |
| (B) | A-600 | 40 | 50 | 30 | 25 | 30 | 25 | 25 | 10 | 18 |
| | A-1000 | | | | | | | | | |
| | A-BPE-10 | | | | | | | | | |
| | A-BPE-30 | | | | | | | | | |
| | C6DA | | | | | | | | | |
| (C) | HEA | | | | 7 | | 7 | 10 | 18 | 18 |
| | ACMO | | | | | | | | | |
| | MA | | | 3 | 3 | | 3 | | | |
| (D) | 1173 | 0.5 | 0.5 | 0.5 | 0.5 | 0.5 | 0.5 | 0.5 | 0.5 | 0.5 |
| | TPO | 0.5 | 0.5 | 0.5 | 0.5 | 0.5 | 0.5 | 0.5 | 0.5 | 0.5 |

| | | | | | | | | | |
|---|---|---|---|---|---|---|---|---|---|
| Abrasion Resistance | B | B | C | B | B | B | B | B | B |
| Fingerprint-wiping | B | B | B | B | C | C | C | B | B |
| Property | | | | | | | | | |
| Water Resistance | C | C | C | B | B | C | C | C | C |
| Releasing Property | B | B | B | B | B | B | B | B | B |

TABLE 9

| Composition | | Comparative Examples | | | | | | | |
|---|---|---|---|---|---|---|---|---|---|
| (Parts) | | 8 | 9 | 10 | 11 | 12 | 13 | 14 | 15 |
| (A) | U-4HA | 40 | 30 | 60 | 70 | | | | |
| | U-6HA | | | | | 73 | | | |
| | TAS | | | | | | 100 | 75 | 50 |
| (B) | A-600 | 60 | 70 | | | 9 | | | |
| | A-1000 | | | | | | | | |
| | A-BPE-10 | | | 40 | 30 | | | | |
| | A-BPE-30 | | | | | | | | |
| | C6DA | | | | | | | 25 | 50 |
| (C) | HEA | | | | | 15 | | | |
| | ACMO | | | | | | | | |
| | MA | | | | | 3 | | | |
| (D) | 1173 | 0.5 | 0.5 | 0.5 | 0.5 | 0.5 | 0.5 | 0.5 | 0.5 |
| | TPO | 0.5 | 0.5 | 0.5 | 0.5 | 0.5 | 0.5 | 0.5 | 0.5 |

| | | | | | | | | |
|---|---|---|---|---|---|---|---|---|
| Abrasion | B | D | B | C | C | B | B | D |
| Resistance | | | | | | | | |
| Fingerprint- | B | B | D | D | B | D | D | D |
| wiping | | | | | | | | |
| Property | | | | | | | | |
| Water | D | D | B | B | D | C | C | C |
| Resistance | | | | | | | | |
| Releasing | B | B | B | B | B | D | B | B |
| Property | | | | | | | | |

TABLE 10

| | | | | | | | Comparative | | |
|---|---|---|---|---|---|---|---|---|---|
| Composition | | Examples | | | | | Examples | | |
| (Parts) | | 47 | 48 | 49 | 50 | 51 | 16 | 17 | 18 |
| (A) | UA | 65 | 50 | 50 | 50 | 45 | 85 | 50 | |
| | DPHA- | | | 20 | 20 | 25 | | | |
| | 12EO | | | | | | | | |
| | TMPT- | | | | | | | | 70 |
| | 9EO | | | | | | | | |
| (B) | A-600 | 35 | 50 | 30 | 25 | 25 | 15 | | 30 |
| | A-400 | | | | | | | 50 | |
| (C) | MA | | | | 5 | 5 | | | |
| (D) | 1173 | 0.5 | 0.5 | 0.5 | 0.5 | 0.5 | 0.5 | 0.5 | 0.5 |
| | TPO | 0.5 | 0.5 | 0.5 | 0.5 | 0.5 | 0.5 | 0.5 | 0.5 |

| | | | | | | | | |
|---|---|---|---|---|---|---|---|---|
| Abrasion | B | B | B | B | B | C | B | D |
| Resistance | | | | | | | | |
| Fingerprint- | B | B | B | B | B | C | D | B |
| wiping | | | | | | | | |
| Property | | | | | | | | |
| Water | B | C | B | B | B | B | B | D |
| Resistance | | | | | | | | |
| Releasing | B | B | B | D | B | B | B | B |
| Property | | | | | | | | |

As is apparent from the results of the Tables, the articles obtained in Examples 1 to 51 have excellent abrasion resistance, fingerprint-wiping properties, and water resistance.

On the other hand, in the articles obtained in Comparative Examples 1 to 3, specific polyfunctional monomers were not used; therefore, the cured resin layers were hard, and were easy to break, and therefore, satisfactory abrasion resistance was not obtained.

In the articles obtained in Comparative Examples 4 to 6 and Comparative Examples 10 to 11, the number of oxyalkylene groups in the difunctional monomers was small, and satisfactory abrasion resistance and fingerprint-wiping properties were not obtained.

In the articles obtained in Comparative Examples 7 to 9, there were too many difunctional monomers, and fingerprint-wiping properties were shown, however, the cured resin layers were prone to absorption, the protrusion units were softened and were adhered with each other, and as a result, optical performances were compromised.

In the articles obtained in Comparative Example 12, there were too few difunctional monomers, fingerprint-wiping properties were shown by HEA, however, the cured resin layers were prone to absorption, the protrusion units were softened and were adhered to each other, and as a result, optical performances were compromised.

In the articles obtained in Comparative Examples 13 to 15, fingerprint-wiping properties were not shown since specific difunctional monomers were not used.

In the articles obtained in Comparative Example 16, fingerprint-wiping properties were slightly inferior since there were too few difunctional monomers. In addition, there were too many difunctional monomers and abrasion resistance was also slightly inferior.

In the articles obtained in Comparative Example 17, satisfactory fingerprint-wiping properties were not obtained since the number of oxyalkylene groups in the functional monomers was small.

In the articles obtained in Comparative Example 18, the cured resin layers became weak since specific polyfunctional monomers were not used and satisfactory abrasion resistance was not obtained. In addition, the cured resin layers were prone to absorption, the protrusion units were softened and were attached to each other, and as a result, optical performances were compromised.

### Reference Example 1

55 parts of U-4HA,

35 parts of A-600,

10 parts of MA,

0.5 parts of 1173, and

0.5 parts of TPO

were mixed and the active energy ray-curable resin composition was prepared.

After the active energy ray-curable resin composition were added dropwise in between the two sheets of polymethyl methacrylate films (manufactured by Mitsubishi Rayon Co., Ltd., HBS010) of thickness of 75 μm and were spread in between the films, the composition was cured by ultraviolet radiation with energy of 2000 mJ/cm² using a high-pressure mercury lamp, and a laminated body of film/cured resin layer/film was obtained. The results are shown in Table 11.

### Reference Examples 2 to 15

Laminated bodies were obtained in the same manner as that of Example 1 except that the compositions of the active energy ray-curable resin composition were changed to compositions shown in Table 11 and Table 12. The results are shown in Table 11 and Table 12.

TABLE 11

| Composition | | Reference Examples | | | | | | | |
|---|---|---|---|---|---|---|---|---|---|
| (Parts) | | 1 | 2 | 3 | 4 | 5 | 6 | 7 | 8 |
| (A) | U-4HA | 55 | 65 | 65 | 65 | 65 | 60 | 60 | 60 |
| | U-6HA | | | | | | | | |
| | TAS | | | | | | | | |
| (B) | A-600 | 35 | 25 | 25 | 25 | 25 | 30 | 30 | 37 |
| (C) | HEA | | 8 | 7 | 5 | 3 | 7 | 5 | |
| | ACMO | | | | | | | | |
| | MA | 10 | 2 | 3 | 5 | 7 | 3 | 5 | 3 |
| (D) | 1173 | 0.5 | 0.5 | 0.5 | 0.5 | 0.5 | 0.5 | 0.5 | 0.5 |
| | TPO | 0.5 | 0.5 | 0.5 | 0.5 | 0.5 | 0.5 | 0.5 | 0.5 |

| | | | | | | | | |
|---|---|---|---|---|---|---|---|---|
| Adhesion | A | C | B | B | A | B | B | B |

TABLE 12

| Composition | | Reference Examples | | | | | | |
|---|---|---|---|---|---|---|---|---|
| (Parts) | | 9 | 10 | 11 | 12 | 13 | 14 | 15 |
| (A) | U-4HA | 60 | 67 | 68 | 63 | | | |
| | U-6HA | | | | | 67 | 65 | |
| | TAS | | | | | | | 65 |
| (B) | A-600 | 35 | 30 | 22 | 27 | 30 | 25 | 25 |
| (C) | HEA | | | 7 | 7 | | 7 | 7 |
| | ACMO | | | | | | | |
| | MA | 5 | 3 | 3 | 3 | 3 | 3 | 3 |
| (D) | 1173 | 0.5 | 0.5 | 0.5 | 0.5 | 0.5 | 0.5 | 0.5 |
| | TPO | 0.5 | 0.5 | 0.5 | 0.5 | 0.5 | 0.5 | 0.5 |

| | | | | | | | |
|---|---|---|---|---|---|---|---|
| Adhesion | B | B | B | B | B | B | B |

As is apparent from the results of the table, the cured resin layers had sufficient adhesion to the acrylic films in the laminated body obtained in the Reference Examples 1 to 15.

### INDUSTRIAL APPLICABILITY

An article having a fine concave-convex structure obtained by curing an active energy ray-curable resin composition of the present invention achieves both an excellent fingerprint-wiping property and high abrasion resistance while maintaining excellent optical performance, and therefore, may be used for various displays such as a television, a mobile phone, a mobile game console and the like, and is extremely useful industrially. The article can be also used for mirrors of which visibility becomes worse by water droplets being adhered, and also for window materials.

### REFERENCE SIGNS LIST

12 Pore (reversed structure of the fine concave-convex structure)
18 Stamper mold
20 Roll-shaped stamper mold
40 Article

1. An active energy ray-curable resin composition comprising:
a polymerizable component (X); and
a photopolymerization initiator (D),
(Polymerizable Component (X))
wherein the polymerizable component (X) comprises 50 to 80% by mass of a monomer (A) having 3 or more radical-polymerizable functional groups within a molecule and a molecular weight per functional group is 110 to 200,
10 to 50% by mass of a monomer (B) having 2 radical-polymerizable functional groups within a molecule and 11 or more oxyalkylene groups within a molecule, and,
0 to 20% by mass of a monomer (C) having one radical-polymerizable functional group within a molecule.

2. The active energy ray-curable resin composition according to claim 1,
wherein the monomer (A) has 3 to 15 radical-polymerizable functional groups within the molecule.

3. The active energy ray-curable resin composition according to claim 1,
wherein the monomer (A) is a monomer having a structure derived from at least one compound selected from the group consisting of trimethylolpropane, trimethylolethane, pentaerythritol, glycerol, hexamethylene diisocyanate and isophorone diisocyanate.

4. The active energy ray-curable resin composition according to claim 1,
wherein the monomer (A) is at least one monomer selected from the group consisting of trimethylolpropane triacrylate, ethoxylated trimethylolpropane triacrylate, ethoxylated pentaerythritol tetraacrylate, tetrafunctional urethane-based hard acrylate, hexafunctional urethane-based hard acrylate, a reaction mixture of trimethylolethane/acrylic acid/succinic acid=2/4/1, di- to nonafunctional urethane acrylate and ethoxylated dipentaerythritol hexaacrylate.

5. The active energy ray-curable resin composition according to claim 1,
wherein the monomer (B) is a monomer having 11 to 30 oxyalkylene groups within the molecule.

6. The active energy ray-curable resin composition according to claim 1,
wherein the monomer (B) is at least one monomer selected from the group consisting of polyethylene glycol diacrylate and ethoxylated bisphenol A diacrylate.

7. The active energy ray-curable resin composition according to claim 1,
wherein the monomer (C) is at least one monomer selected from the group consisting of acryloyl morpholine, hydroxyethyl acrylate, N,N-dimethyl acrylamide,
N-vinyl pyrrolidone, N-vinyl formamide, methyl acrylate and ethyl acrylate.

8. The active energy ray-curable resin composition according to claim 1,
wherein the monomer (C) is at least one monomer selected from the group consisting of 2-hydroxyethyl acrylate, acryloyl morpholine, and methyl acrylate.

9. The active energy ray-curable resin composition according to claim 1,
wherein the ratio of the photopolymerization initiator (D) is 0.01 to 10 parts by mass with regard to 100 parts by mass of the polymerizable component (X).

10. The active energy ray-curable resin composition according to claim 1,
wherein the photopolymerization initiator (D) is 2-hydroxy-2-methyl-1-phenylpropan-1-one or 2,4,6-trimethyl benzoyl diphenylphosphine oxide.

11. An article having a fine concave-convex structure on a surface,
wherein the fine concave-convex structure is formed by contacting the active energy ray-curable resin composition according to claim 1 with a stamper mold having a reversed structure of the fine concave-convex structure on the surface and curing the active energy ray-curable resin composition.

12. The article having the fine concave-convex structure on the surface according to claim 11, which is an anti-reflective product.
